(19) United States
(12) Patent Application Publication
(10) Pub. No.: US 2024/0411089 A1
(43) Pub. Date: Dec. 12, 2024

(54) OPTICAL CONNECTION DEVICE AND OPTICAL SWITCH USING IT

(71) Applicant: NIPPON TELEGRAPH AND TELEPHONE CORPORATION, Tokyo (JP)

(72) Inventors: Chisato FUKAI, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/701,750

(22) PCT Filed: Oct. 19, 2021
(86) PCT No.: PCT/JP2021/038536

§ 371 Date: Apr. 16, 2024

(51) Int. Cl. G02B 6/38; G02B 6/35; G02B 6/40

(52) U.S. Cl. CPC G02B 6/3874; G02B 6/3504; G02B 6/3871; G02B 6/403

(57) ABSTRACT

An object of the present disclosure is to enable an optical switch capable of driving stable optical characteristics with respect to external factors with low power consumption to be achieved at low cost.

The present disclosure is an optical connection device that connects a first ferrule and a second ferrule, the optical connection device including: a cylindrical sleeve into which the first ferrule and the second ferrule are inserted; a spring that abuts a distal end portion of the first ferrule and a distal end portion of the second ferrule on each other; and a holder that holds the first ferrule, the second ferrule, the cylindrical sleeve, and the spring, in which the first ferrule or the second ferrule is movable in any direction perpendicular to a central axis in the holder, and is held by the holder so as not to rotate about the central axis.

### TECHNICAL FIELD

The present disclosure relates to an optical connection device to be used mainly for switching paths among optical fiber lines using single-mode optical fibers in an optical fiber network, and an optical switch using the optical connection device.

### BACKGROUND ART

For an all-optical switch that performs path switching while keeping light as it is, various systems have been suggested as disclosed in Non Patent Literature 1, for example. Among these systems, an optical-fiber-type mechanical optical switch that controls abutment between optical fibers or optical connectors with a motor or the like is inferior to the other systems in that the switching speed is low, but has many aspects at which the mechanical optical switch is superior to the other systems in terms of low loss, low wavelength dependence, multi-port properties, and a self-holding function of holding the switching state at a time when the power supply is stopped. Representative examples of such structures include a system in which a stage using an optical fiber V-shaped groove is moved in parallel, for example, and a system in which a mirror or a prism is moved in parallel or is made to change its angle so as to selectively couple an incident optical fiber with a plurality of exit optical fibers.

Further, a system of rotating a cylindrical ferrule into which a multi-core fiber is inserted to perform switching (see Patent Literature 1, for example) is proposed, and this system eliminates necessity of optical components such as lenses and prisms, and can simplify the optical switch configuration.

In the optical path switching disclosed in Patent Literature 1 in which a cylindrical ferrule into which a multicore fiber is inserted is rotated by a motor to perform switching, the ferrule is inserted into a sleeve to align central axes, and a rotation axis of a shaft moves horizontally and vertically during the rotation of the motor, so that a rotation axis of the rotating ferrule also moves horizontally and vertically on an end surface of the ferrule. Therefore, there is a problem that an excessive side pressure is generated between the ferrule and the sleeve, frictional force increases, large energy is required for driving the rotation, and large electric power is required. Further, there is a problem that the ferrule or the sleeve is damaged when a large side pressure is applied. In addition, when the ferrule rotates, for the purpose of preventing deterioration of optical characteristics such as a connection loss by scratching opposing fiber end surfaces, a mechanism is required for separating the ferrule end surfaces every time the ferrule rotates, and there is a problem that extra energy is required for driving the rotation.

On the other hand, there is also a method of, in a cylindrical ferrule into which an optical fiber is inserted, preventing damage to a fiber end surface due to contact by a connection form (for example, Non Patent Literature 2) in which a gap is provided in advance and fiber contact is not performed. However, in order to suppress signal deterioration due to reflection caused by an air layer generated between fiber end surfaces due to the gap, a special coating for preventing reflection is required, and there is a problem that cost increases.

As another method for preventing reflection, there is also a method of obliquely polishing the end surface of the ferrule (for example, Non Patent Literature 3). However, in the case of an obliquely polished ferrule, there is a problem that interference of an end surface of the ferrule occurs at the time of switching by rotation, or a large gap is required, so that a connection loss increases.

### CITATION LIST

### Patent Literature

Patent Literature 1: JP 02-82212 A

### Non Patent Literature

Non Patent Literature 1: M. Ctepanovsky, “A Comparative Review of MEMS-Based Optical Cross-Connects for All-Optical Networks From the Past to the Present Day,” IEEE Communications Surveys & Tutorials, vol. 21, no. 3, pp. 2928-2946, 2019.
Non Patent Literature 2: B. Jian, “The Non-Contact Connector: A New Category of Optical Fiber Connector,” 2015 Optical Fiber Communications Conference and Exhibition (OFC), W2A.1, 2015.
Non Patent Literature 3: Hajime Arao, Sho Yakabe, Fumiya Uehara, Dai Sasaki, and Takayuki Shimazu, “FlexAirConnecT-Dust Insensitive Multi-Fiber Connector with Low Loss and Low Mating Force-” SEI Technical Review of July 2018, No. 193, pp. 26-31, 2018.

### SUMMARY OF INVENTION

### Technical Problem

In order to solve the above problem, an object of the present disclosure is to enable an optical switch capable of driving stable optical characteristics with respect to external factors with low power consumption to be achieved at low cost.

### Solution to Problem

An optical switch of the present disclosure includes:
an optical connection device according to the present disclosure; and
a rotation mechanism that rotates one of a first ferrule and a second ferrule provided in the optical connection device about a central axis of the first ferrule and the second ferrule.

An optical connection device according to the present disclosure includes:
a first ferrule in which core centers of one or a plurality of single-core fibers are arranged on an identical circumference from a center in a ferrule cross section;
a second ferrule in which core centers of a plurality of single-core fibers are arranged on a circumference having the same diameter as a diameter of the circumference on which the core centers of the single-core fibers in the first ferrule are arranged, from a center in a ferrule cross section; and
a cylindrical sleeve having a hollow portion into which the first ferrule and the second ferrule are inserted so that a central axis of the first ferrule and a central axis of the second ferrule match each other, and having a predetermined gap between outer diameters of the first ferrule and the second ferrule and an inner diameter of the hollow portion so that the first ferrule or the second ferrule is rotatable.

The optical connection device of the present disclosure achieves low power consumption of the optical switch by suppressing an increase in frictional force due to deflection of the rotation axes at the connection portion between the first ferrule and the second ferrule.

Specifically, the optical connection device of the present disclosure includes:
a spring that applies pressure to a first flange of the first ferrule or a second flange of the second ferrule so that a distal end portion of the first ferrule and a distal end portion of the second ferrule abut on each other; and
a holder that holds the first ferrule, the second ferrule, the cylindrical sleeve, the first flange, the second flange, and the spring such that the central axis of the first ferrule and the central axis of the second ferrule match each other,
in which the first ferrule or the second ferrule is movable in any direction perpendicular to the central axis in the holder, and is held by the holder so as not to rotate about the central axis.

### Advantageous Effects of Invention

According to the present disclosure, it is possible to provide an optical switch capable of driving stable optical characteristics with respect to external factors with low power consumption at low cost in order to suppress an increase in frictional force due to deflection of rotation axes at a connection portion between a first ferrule and a second ferrule.

### BRIEF DESCRIPTION OF DRAWINGS

FIG. 1 illustrates an example of a usage mode of an optical switch of the present disclosure.

FIG. 2 is a configuration diagram of an optical switch using an optical connection device according to an embodiment of the present disclosure.

FIG. 3 is a configuration diagram of the optical connection device according to the embodiment of the present disclosure.

FIG. 4 is a schematic diagram illustrating an end portion of a fixed-side ferrule according to the embodiment of the present disclosure when viewed from the front.

FIG. 5 is a schematic diagram illustrating an end portion of a rotating-side ferrule according to the embodiment of the present disclosure when viewed from the front.

FIG. 6 is a schematic diagram illustrating a ferrule and a cylindrical sleeve of the optical connection device according to the embodiment of the present disclosure in a plane along a longitudinal direction.

FIG. 7 illustrates an example of a relationship of excessive loss with respect to a clearance between a ferrule outer diameter and a sleeve inner diameter.

FIG. 8 is a schematic diagram illustrating the vicinity of the end portion of the ferrule of the optical connection device according to the embodiment of the present disclosure in more detail.

FIG. 9 illustrates an example of a relationship between an angle formed by distal end portions and an annular portion and a reflection attenuation amount.

FIG. 10 illustrates an example of a relationship of excessive loss with respect to a gap of an optical fiber.

FIG. 11 illustrates an example of a relationship of excessive loss due to a rotational angle deviation with respect to a core arrangement radius.

FIG. 12 is a schematic diagram illustrating a cross section of the inside of a fixed-side flange holding unit according to a first embodiment of the present disclosure.

FIG. 13 is a schematic diagram illustrating a cross section of the inside of a fixed-side flange holding unit according to a second embodiment of the present disclosure.

### DESCRIPTION OF EMBODIMENTS

The following describes embodiments of the present disclosure in detail with reference to the drawings. The present invention is not limited to the embodiments described below. These embodiments are merely examples, and the present disclosure can be implemented in a form with various modifications and improvements based on the knowledge of those skilled in the art. Note that components having the same reference signs in the present specification and the drawings indicate the same components.

### First Embodiment

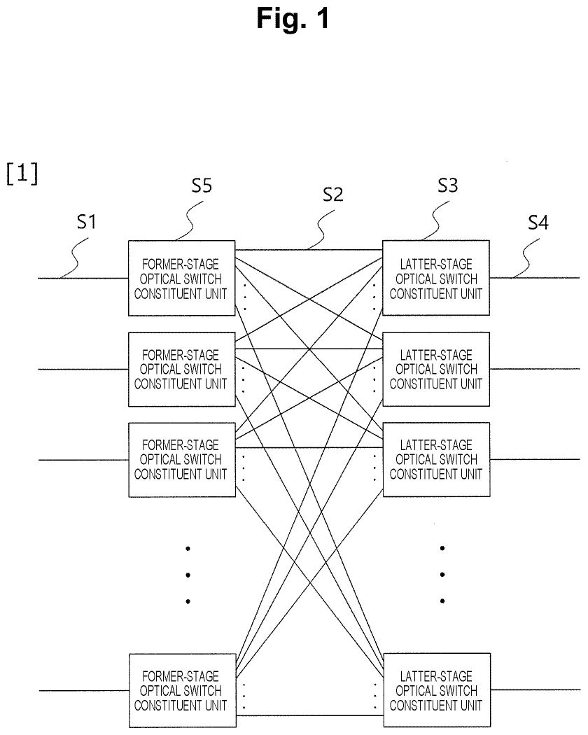

FIG. 1 is a diagram illustrating an example of an embodiment of the present disclosure. According to the present disclosure, an input-side optical fiber S1 connected to a former-stage optical switch constituent unit S5 can be switched to a specific port of an inter-optical-switch optical fiber S2 at the former-stage optical switch constituent unit S5, and the port of the inter-optical-switch optical fiber S2 can be switched to a desired output-side optical fiber S4 at a latter-stage optical switch constituent unit S3.

The optical switch of the present disclosure is an optical switch corresponding to the former-stage optical switch constituent unit S5 and the latter-stage optical switch constituent unit S3. The optical switch of the present disclosure includes an optical connection device of the present disclosure. Hereinafter, the former-stage optical switch constituent unit S5 will be referred to simply as the optical switch S5, and the latter-stage optical switch constituent unit S3 will be referred to simply as the optical switch S3. In the present embodiment, a mode in which light is incident from the input-side optical fiber S1 and is emitted to the output-side optical fiber S4 will be described, but the direction of the light may be reversed. Since the optical switch S5 and the optical switch S3 are in a left-right inversion relationship and have the same configuration, a detailed configuration will be described below using the optical switch S5.

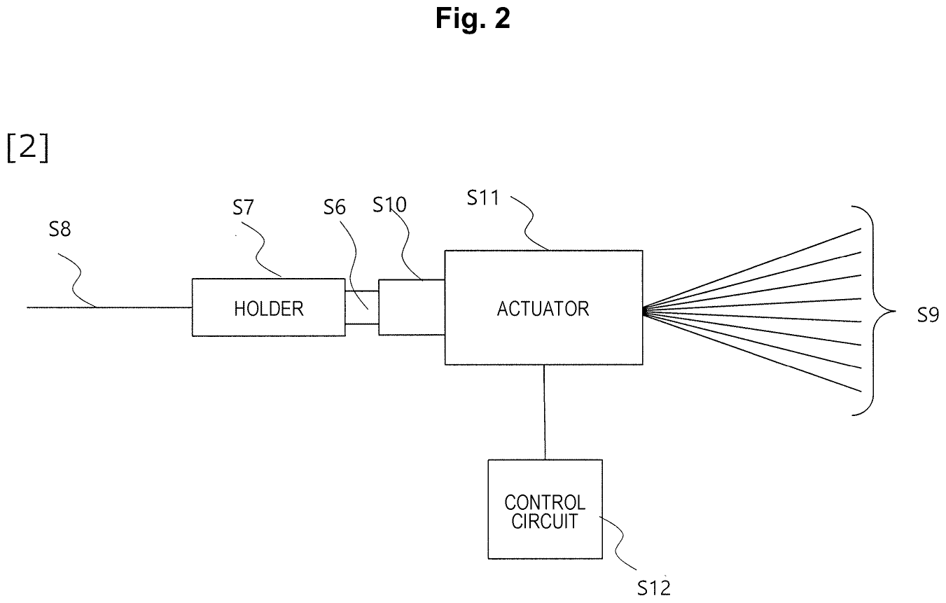

FIG. 2 is a configuration diagram of an example of the optical switch S5 using the optical connection device of the present disclosure. The optical switch includes a holder S7, a rotating-side flange S6, a rotation mechanism S10, and an actuator S11 in this order from the fixed-side optical fiber S8 side. The fixed-side optical fiber S8 corresponds to the input-side optical fiber S1 illustrated in FIG. 1, and the rotating-side optical fiber S9 corresponds to the inter-optical-switch optical fiber S2 illustrated in FIG. 1.

The actuator S11 performs rotation by any angle by a signal from a control circuit S12. The rotating-side flange S6 rotates when the output of the actuator S11 is transmitted via the rotation mechanism S10. In FIG. 2, since the rotational power is directly transmitted to the rotating-side flange S6, the actuator S11 and the rotation mechanism S10 have a hollow structure, and the rotating-side optical fiber S9 can pass through a hollow portion of the actuator S11 and the rotation mechanism S10.

For example, a motor is used as the actuator S11, and at this time, the rotation mechanism S10 is configured by a shaft of the motor. Although FIG. 2 illustrates an example of the hollow actuator S11 and rotation mechanism S10, for example, non-hollow actuator S11 and rotation mechanism S10 can be used by installing a gear between the rotating-side flange S6 and the rotation mechanism S10. The rotating-side optical fiber S9 may be provided with a certain extra length portion for allowing torsion due to rotation.

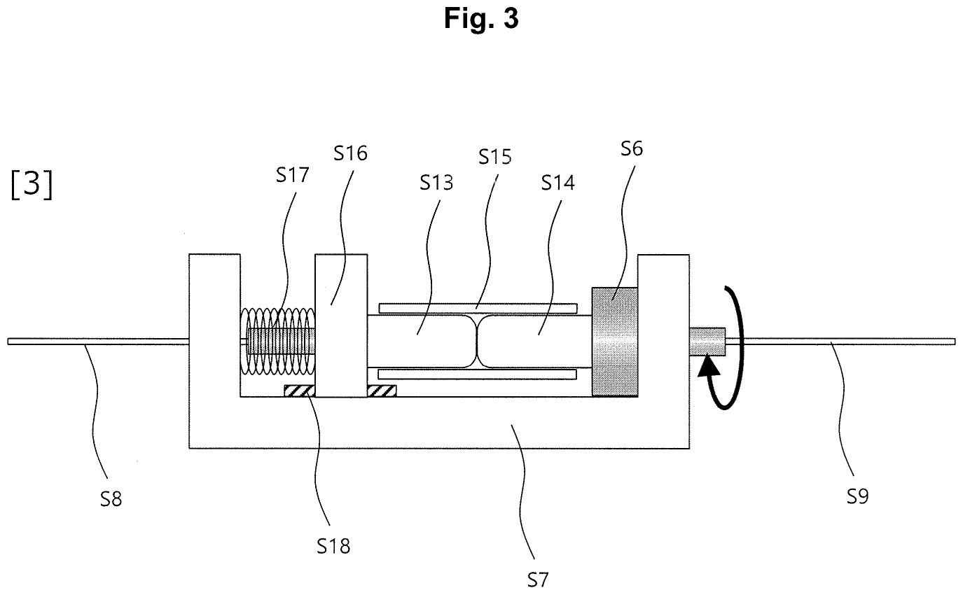

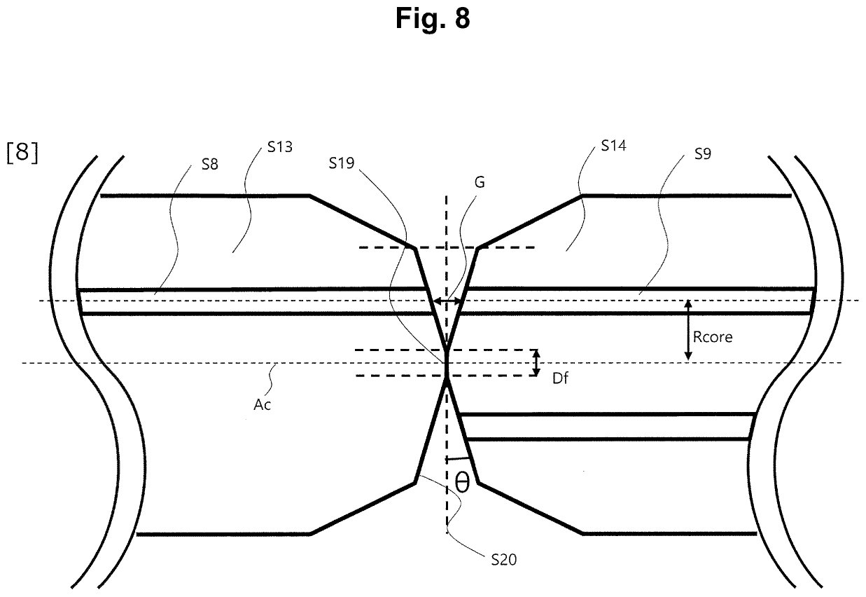

FIG. 3 is a configuration diagram of the optical connection device according to the embodiment of the present disclosure. In the optical connection device included in the optical switch S5 according to the present embodiment, a fixed-side ferrule S13 to which the fixed-side flange (not illustrated) is attached, a rotating-side ferrule S14 to which the rotating-side flange S6 is attached, a cylindrical sleeve S15 into which the fixed-side ferrule S13 and the rotating-side ferrule S14 are inserted, and a spring S17 are held by the holder S7 such that the central axis of the fixed-side ferrule S13 and the central axis of the rotating-side ferrule S14 (reference sign Ac illustrated in FIG. 8) match each other.

A fixed-side flange holding unit S16 is slidable in the holder S7 in a direction in which the fixed-side ferrule S13 is pressed against the rotating-side ferrule S14, that is, in a direction parallel to the central axis. The fixed-side flange holding unit S16 is provided with a groove that engages with a flange holding unit fixing protrusion portion S18. When the groove of the fixed-side flange holding unit S16 engages with the flange holding unit fixing protrusion portion S18, the fixed-side flange holding unit S16 is fixed to the holder S7 so as not to axially rotate about the central axes of the fixed-side ferrule S13 and the rotating-side ferrule S14.

The spring S17 applies pressure to an outer frame portion (reference sign S27 to be described later) of the fixed-side flange holding unit S16 so that the distal end portions of the fixed-side ferrule S13 and the rotating-side ferrule S14 abut on each other. The end surfaces of the fixed-side ferrule S13 and the rotating-side ferrule S14 abut on each other by being pressed by the spring S17 attached to the fixed-side flange holding unit S16. In the rotating-side ferrule S14 and the rotating-side flange S6, bearings or low friction processing may be performed in order to reduce the driving force for rotation.

The fixed-side optical fiber S8 corresponds to the input-side optical fiber S1 in FIG. 1, and the rotating-side optical fiber S9 corresponds to the inter-optical-switch optical fiber S2 in FIG. 1. When light is incident from the fixed-side optical fiber S8, the fixed-side ferrule S13 is fixed, the fixed-side optical fiber S8 is connected to any one core of the rotating-side optical fiber S9 by rotating the rotating-side ferrule S14, and the incident light can be output from one core of the rotating-side optical fiber S9, and the optical switch can be used as a 1× N relay type optical switch.

Conversely, light can be incident from the rotating-side optical fiber S9. For example, light can be made incident on a plurality of single-core fibers of the rotating-side optical fiber S9 to rotate the rotating-side ferrule S14, so that any one of the rotating-side optical fibers S9 is connected to the fixed-side optical fiber S8, and only one piece of light selected from the plurality of pieces of incident light is output from the fixed-side optical fiber S8.

As illustrated in FIG. 1, an N×N optical switch can be configured by combining a plurality of optical switches. Here, although one fixed-side optical fiber S8 is used, a plurality of optical fibers can be arranged. The number of the fixed-side optical fibers S8 is one, and the number of the rotating-side optical fibers S9 is plural. However, the number of the rotating-side optical fibers S9 may be one, and the number of the fixed-side optical fibers S8 may be plural. In this case, the fixed-side optical fiber S8 corresponds to the inter-optical-switch optical fiber S2 in FIG. 1, and the rotating-side optical fiber S9 corresponds to the input-side optical fiber S1 in FIG. 1. Hereinafter, an optical switch S5 including one fixed-side optical fiber S8 and a plurality of rotating-side optical fibers S9 will be described.

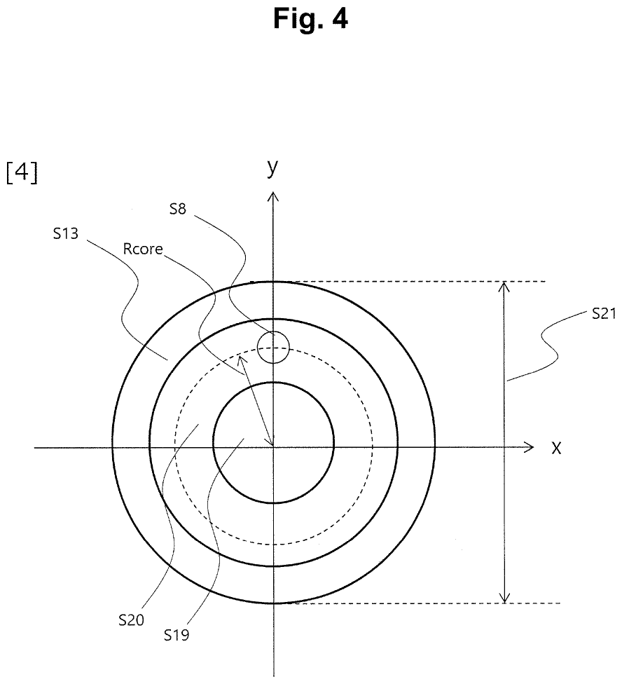

FIG. 4 is a schematic diagram illustrating an end portion of the fixed-side ferrule S13 according to the embodiment of the present disclosure when viewed from the front. As illustrated in FIG. 4, the core center of the fixed-side optical fiber S8 is arranged on the circumference of a circle having a core arrangement radius Rcore with respect to the center of the fixed-side ferrule S13.

Although FIG. 4 illustrates an example in which one fixed-side optical fiber S8 is arranged on the y axis (x=0), it is sufficient that the core center of the fixed-side optical fiber S8 is arranged on the circumference of a circle having the core arrangement radius Rcore, and the present invention is not limited thereto. The fixed-side optical fiber S8 is arranged in an annular portion S20 arranged outside a distal end portion S19. The end surface of the fixed-side optical fiber S8 is exposed to the annular portion S20.

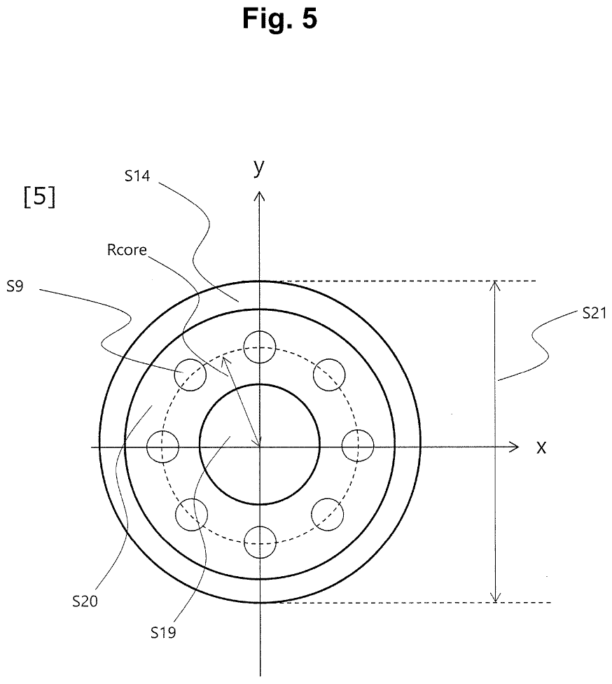

FIG. 5 is a schematic diagram illustrating an end portion of a rotating-side ferrule S14 according to the embodiment of the present disclosure when viewed from the front. As illustrated in the drawing, the core center of each of the plurality of rotating-side optical fibers S9 is arranged on the circumference of a circle having a core arrangement radius Rcore with respect to the center of the rotating-side ferrule S14. Although FIG. 5 illustrates an example in which a total of eight rotating-side optical fibers S9 are arranged, it is sufficient that the core centers of the plurality of rotating-side optical fibers S9 are arranged on the circumference of a circle having the core arrangement radius Rcore, and the present invention is not limited thereto. As similar to the fixed-side optical fiber S8, the rotating-side optical fiber S9 is arranged in the annular portion S20 arranged outside a distal end portion S19. The end surface of the rotating-side optical fiber S9 is exposed to the annular portion S20.

It is important to minimize the transmission loss in the connection between the fixed-side optical fiber S8 and the rotating-side optical fiber S9, and it is desirable that the cores of the rotating-side optical fiber S9 have the same optical characteristics in terms of having a mode field diameter similar to that of the core of the fixed-side optical fiber S8. It is important to minimize the excessive loss due to the axial deviation, and it is desirable that the ferrule outer diameter S21 of the rotating-side ferrule S14 is substantially the same as the ferrule outer diameter S21 of the fixed-side ferrule S13.

In the present embodiment, the fixed-side optical fiber S8 and the rotating-side optical fiber S9 are made of quartz glass, but it is not limited thereto as long as it is an optical fiber capable of communicating signal light in a communication wavelength band. In the present embodiment, an example in which the distal end portions S19 of the fixed-side ferrule S13 and the rotating-side ferrule S14 are flat surfaces is shown, but the distal end portion S19 does not need to have a flat shape, and for example, one of the fixed-side ferrule S13 and the rotating-side ferrule S14 may have a convex shape and the other may have a concave shape in close contact with the convex shape.

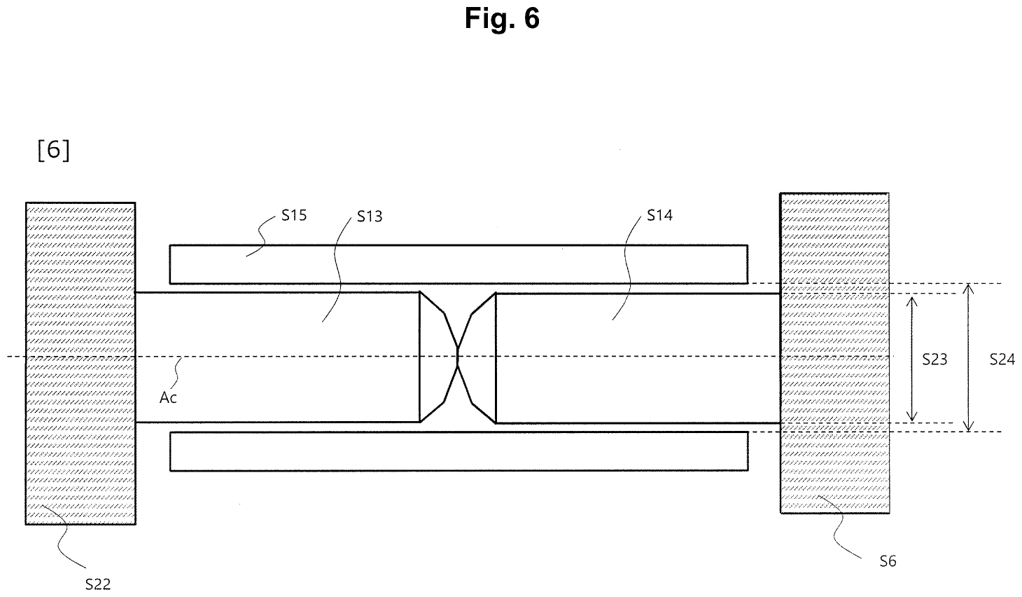

FIG. 6 is a schematic diagram illustrating the ferrule and the cylindrical sleeve of the optical connection device according to the embodiment of the present disclosure in a plane along a longitudinal direction. The cylindrical sleeve S15 has a hollow portion, and the fixed-side ferrule S13 and the rotating-side ferrule S14 are inserted into the hollow portion. At this time, the central axes Ac of the fixed-side ferrule S13 and the rotating-side ferrule S14 match each other.

A predetermined gap is provided between the outer diameters of the fixed-side ferrule S13 and the rotating-side ferrule S14 and the inner diameter of the hollow portion so that the rotating-side ferrule S14 can rotate about the central axis Ac. The fixed-side ferrule S13 into which the fixed-side optical fiber S8 is inserted and the rotating-side ferrule S14 into which the rotating-side optical fiber S9 is inserted are aligned by the cylindrical sleeve S15 having an inner diameter slightly larger than the outer diameter S23 of the ferrules by about sub μm, and the axial deviation is controlled within a certain allowable range. A slight clearance C of about sub μm is provided for the fixed-side ferrule S13 and the rotating-side ferrule S14 in order not to hinder the axial rotation of the rotating-side ferrule S14.

In order to abut the end surfaces of the fixed-side ferrule S13 and the rotating-side ferrule S14, the length of the cylindrical sleeve S15 in the longitudinal direction is set to be shorter than the sum of the length of the fixed-side ferrule S13 in the longitudinal direction and the length of the rotating-side ferrule S14 in the longitudinal direction, that is, the distance between the fixed-side flange S22 and the rotating-side flange S6.

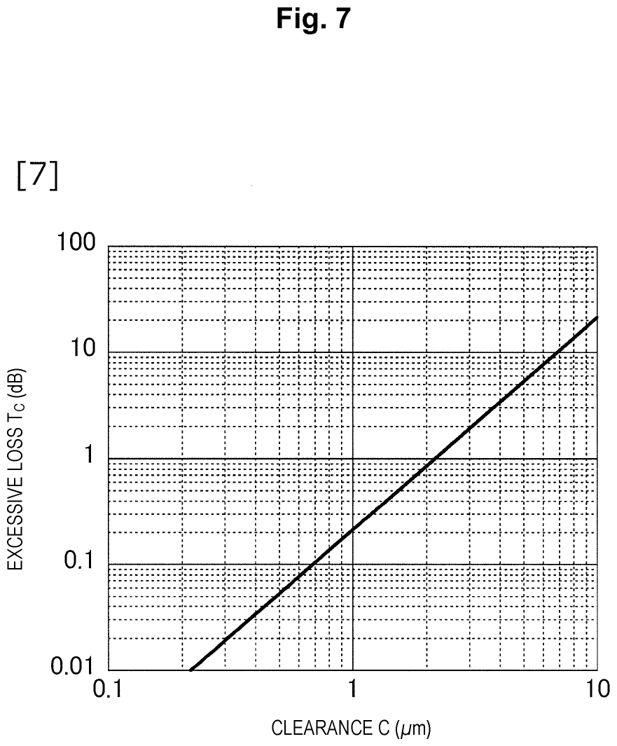

FIG. 7 is a diagram illustrating an example of the relationship between the excessive loss Tc with respect to the clearance C between the ferrule outer diameter S23 of the fixed-side ferrule S13 and the rotating-side ferrule S14 and the sleeve inner diameter S24 of the cylindrical sleeve S15. In optical coupling between optical fibers, axial deviation of a fiber core causes excessive loss. Since an increase in the excessive loss becomes a factor limiting the whole length of the optical path, it is necessary to reduce the axial deviation of the fiber core.

Since the clearance C between the ferrule outer diameter S23 and the sleeve inner diameter S24 corresponds to axial deviation of the fiber core, a relationship between excessive loss Tc (unit: dB) and the clearance C (unit: μm) between the ferrule outer diameter S23 and the sleeve inner diameter S24 can be expressed by Expression 1. [Math. 1]

$${T}_{c} = - 10 \times log \{ {( \frac{2 {ω}_{1} {ω}_{2}}{{ω}_{1}^{2} + {ω}_{2}^{2}} )}^{2} exp [ - 1 \times \frac{2 {C}^{2}}{{ω}_{1}^{2} + {ω}_{2}^{2}} ] \} \qquad ( 1 )$$

Here, ω1 and ω2 are mode field radii (unit: μm) of cores of the fixed-side optical fiber S8 and the rotating-side optical fiber S9, respectively.

FIG. 7 illustrates the loss when the mode field radii ω1 and ω2 of the cores of the fixed-side optical fiber S8 and the rotating-side optical fiber S9 are both 4.5 μm. For example, in a case where the ferrule outer diameter S23 and the sleeve inner diameter S24 are processed such that the clearance C is 0.7 μm or less, the maximum excessive loss can be suppressed to about 0.1 dB or less. When the maximum excessive loss is set to 0.2 dB, it is necessary to process the ferrule outer diameter S23 and the sleeve inner diameter S24 such that the clearance C is 1 μm or less.

FIG. 8 is a schematic diagram illustrating the vicinity of the end portion of the ferrule of the optical connection device according to the embodiment of the present disclosure in more detail. The end portions of the fixed-side ferrule S13 and the rotating-side ferrule S14 have convex shapes protruding toward the central axis Ac. The fixed-side ferrule S13 and the rotating-side ferrule S14 abut on each other at the distal end portions S19. FIG. 8 illustrates an example in which the distal end portions S19 are flat surfaces having a diameter Df perpendicular to the central axis Ac.

As described above, the fixed-side optical fiber S8 and the rotating-side optical fiber S9 are arranged in the annular portion S20 of the fixed-side ferrule S13 and the rotating-side ferrule S14, and end surfaces thereof are exposed. The end surfaces of the fixed-side optical fiber S8 and the rotating-side optical fiber S9 are retracted from the distal end portions S19 in order to prevent the end surfaces from coming into contact with each other and being damaged at the time of switching by rotation.

In the end surfaces of the fixed-side optical fiber S8 and the rotating-side optical fiber S9, an angle θ formed by the distal end portions S19 and the annular portion S20 is controlled in order to suppress signal characteristic deterioration due to reflection. In the present embodiment, an example in which the end surface of the annular portion S20 is formed linearly in the direction retreating from the distal end portions S19 is illustrated in FIG. 8, but the annular portion S20 does not need to have a linear shape and may have a spherical shape, for example.

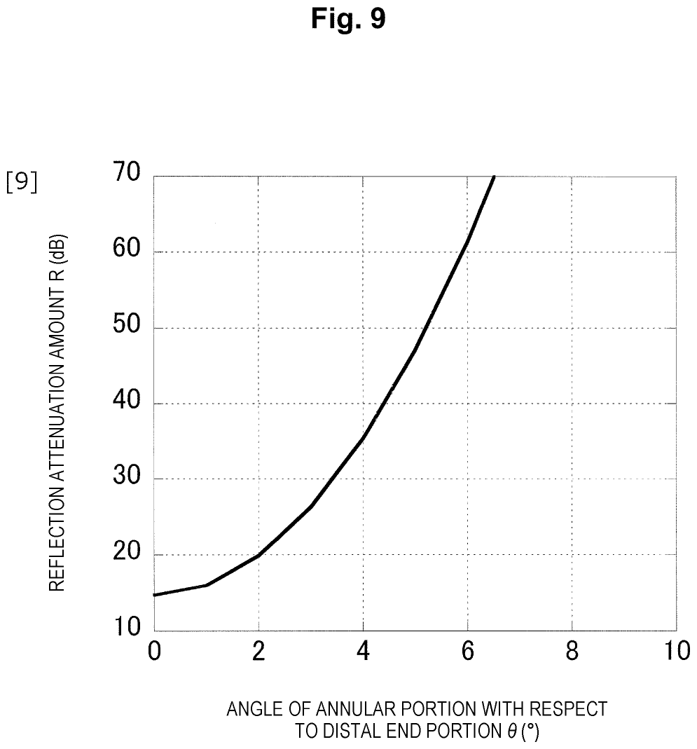

FIG. 9 is a diagram illustrating an example of the relationship between the angle θ of the annular portion S20 with respect to the distal end portions S19 and a reflection attenuation amount R. In the optical connection device, when there is a region having a different refractive index between the end surface of the fixed-side optical fiber S8 and the end surface of the rotating-side optical fiber S9, signal characteristics are deteriorated due to reflection. In the configuration of the present disclosure illustrated in FIG. 8, there is a gap G between the end surface of the fixed-side optical fiber S8 and the end surface of the rotating-side optical fiber S9, and quartz glass and air have different refractive indexes. Therefore, it is necessary to devise to reduce reflection. In the present disclosure, reflection is reduced by controlling the angle θ of the annular portion S20.

The relationship between the angle θ (unit: degree) of the annular portion S20 with respect to the distal end portions S19 and the reflection attenuation amount R (unit: dB) can be expressed by Expression 2.

### [Math. 2]

$$R = 10 \frac{{( π \times {n}_{1} \times {ω}_{1} )}^{2}}{{λ}^{2}} \times log ( e ) \times {( 4 π \frac{θ}{360} )}^{2} + {R}_{0} \qquad ( 2 )$$

Here, n₁, ω₁, and λ are the refractive index of the optical fiber, the mode field radius (unit: μm) of the optical fiber core, and the wavelength (unit: μm) of the propagated light in vacuum, respectively. R₀ is a reflection attenuation amount at the flat end surface, and can be expressed by Expression 3.

### [Math. 3]

$${R}_{o} = - 10 \times log [ {( \frac{{n}_{1} - {n}_{2}}{{n}_{1} + {n}_{2}} )}^{2} ] \qquad ( 3 )$$

Here, n₂ is a refractive index of a light receiving medium.

In the present embodiment, when the wavelength λ is 1310 nm and the mode field radius ω1 is 4.5 μm, the reflection attenuation amount R₀ at the flat end surface is 14.7 dB, and for example, by setting the angle of the annular portion S20 with respect to the distal end portions S19 to 5 degrees or more, the reflection attenuation amount R of 40 dB or more can be maintained.

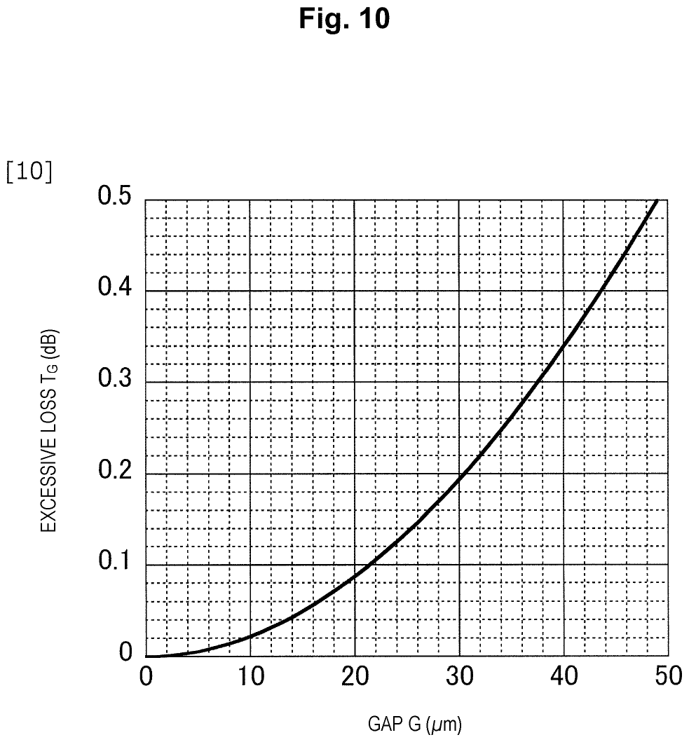

FIG. 10 illustrates an example of a relationship of excessive loss TG with respect to the gap G. In the optical coupling between the fixed-side optical fiber S8 and the rotating-side optical fiber S9, when the gap G exists between the end surface of the fixed-side optical fiber S8 and the end surface of the rotating-side optical fiber S9, the distribution of the emitted light of the fixed-side optical fiber S8 is widened, and the coupling efficiency with the core of the rotating-side optical fiber S9 is reduced, which causes excessive loss.

The relationship between the gap G (unit: μm) and the excessive loss TG (unit: dB) can be expressed by Expression 4.

### [Math. 4]

$${T}_{G} = - 10 \times log \{ \frac{4 ⌈ 4 {G}^{2} + \frac{{ω}_{1}^{2}}{{ω}_{2}^{2}} ]}{{[ 4 {G}^{2} + \frac{{ω}_{2}^{2} + {ω}_{1}^{2}}{{ω}_{2}^{2}} ]}^{2} + 4 {G}^{2} \frac{{ω}_{2}^{2}}{{ω}_{1}^{2}}} \} \qquad ( 4 )$$

Here, ω1 and ω2 are mode field radii of cores of the fixed-side optical fiber S8 and the rotating-side optical fiber S9, respectively.

FIG. 10 illustrates the loss when the mode field radii of the fixed-side optical fiber S8 and the rotating-side optical fiber S9 are both 4.5 μm. For example, by adjusting the gap G between the end surface of the fixed-side optical fiber S8 and the end surface of the rotating-side optical fiber S9 to be 20 μm or less, the excessive loss can be suppressed to 0.1 dB or less.

Next, requirements regarding the actuator S11 in FIG. 2, the fixed-side ferrule S13 described in FIG. 4, and the rotating-side ferrule S14 described in FIG. 5 will be described. The actuator S11 is a driving mechanism that rotates at appropriate angle steps in accordance with a pulse signal from the control circuit S12 and serves as a driving mechanism that has a constant static torque at each angle step. For example, a stepping motor is used.

Any other method may be used, as long as the actuator S11 is a driving mechanism that rotates at appropriate angle steps in accordance with a pulse signal supplied from the control circuit S12, and has a constant static torque at each angle step. A rotation speed and a rotation angle may be determined with cycles and the number of pulses of the pulse signal from the control circuit S12, and the angle steps and a static torque may be adjusted via a reduction gear. As described above, since the rotating-side ferrule S14 in the optical connection device is designed to be freely axially rotated around the central axis Ac, the static torque necessary for holding the rotation angle of the rotating-side ferrule S14 is provided by the actuator S11. As a result, it is possible to provide an optical switch that has a self-holding function that does not require power at the time of being stationary after switching, and that can minimize the driving energy at the time of switching the optical path, and that has low power consumption.

Here, in the stepping motor, when the number of angular steps at which the angular position is held when the power supply is stopped is defined as the number of stationary angular steps, the number of stationary angular steps is a natural number multiple of the number of cores having the same core arrangement radius Rcore of the rotating-side optical fiber S9.

In a case where the excessive loss due to the rotational angle deviation in the optical connection device is denoted by T_{R} (unit: dB), the rotational angle deviation related to the stationary angle accuracy of the stepping motor is denoted by Φ (unit: degree), and the core arrangement radius is denoted by Rcore (unit: μm), these relationships can be expressed by Expression 5.

### [Math. 5]

$${T}_{R} = - 10 log \{ {( \frac{2 {ω}_{1} {ω}_{2}}{{ω}_{1}^{2} + {ω}_{2}^{2}} )}^{2} exp [ - 1 \times \frac{2 ( 2 {R}_{core} sin 2 π \frac{Φ}{360} )}{{ω}_{1}^{2} + {ω}_{2}^{2}} ] \} \qquad ( 5 )$$

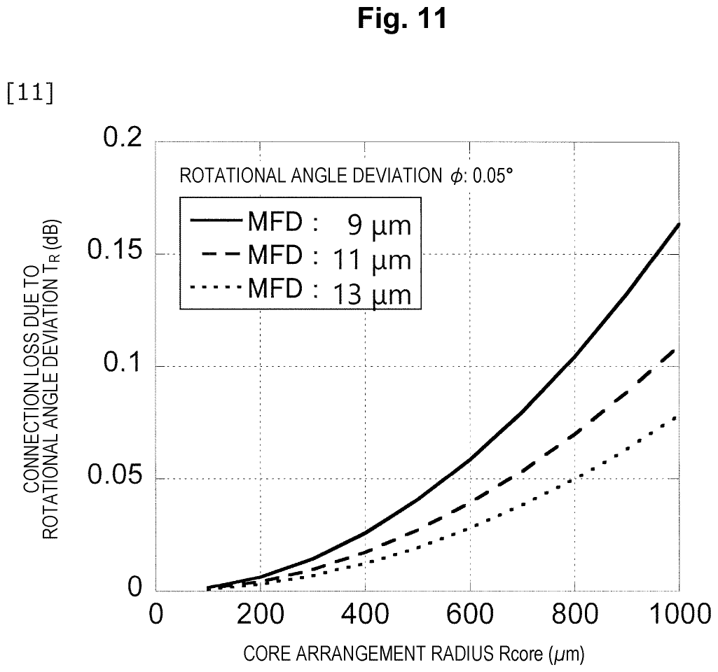

FIG. 11 illustrates an example of a relationship of the excessive loss T_{R} due to a rotational angle deviation with respect to the core arrangement radius Rcore. In general, the angle accuracy of the stepping motor is about 3 to 5%, and in FIG. 11, the rotational angle deviation Φ is set to 0.05 degrees. The larger the core arrangement radius Rcore, the larger the excessive loss, and strict stationary angle accuracy is required. For example, if the excessive loss is 0.1 dB, when the mode field radii ω1 and ω2 are 4.5 μm (MFD=9 μm), the core arrangement radius Rcore needs to be 800 μm or less. When an optical fiber having a larger mode field radius is used, it is also possible to reduce excessive loss.

However, in order to achieve the excessive loss due to the rotational angle deviation illustrated in FIG. 11, it is necessary to stop the fixed-side ferrule S13 with respect to the rotational angle direction. When the rotation mechanism S10 illustrated in FIG. 2 moves horizontally and vertically with respect to the cross section when rotating like a shaft of a motor, for example, the rotation-side ferrule moves horizontally and vertically with respect to the end surface of the ferrule. Therefore, a mechanism is required in which the fixed-side ferrule S13 also moves horizontally and vertically following the rotating-side ferrule S14.

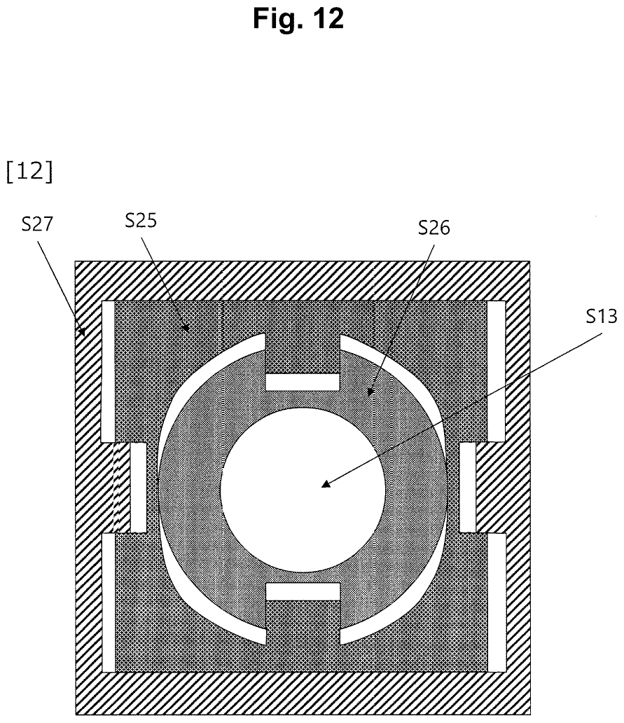

FIG. 12 is a schematic diagram illustrating a cross section of the inside of the fixed-side flange holding unit S16 according to the embodiment of the present disclosure. The fixed-side flange S26 is provided with upper and lower grooves, and an interference portion S25 is provided with a protrusion so as to engage with the upper and lower grooves of the fixed-side flange S26. A gap is provided between the upper and lower portions of the fixed-side flange S26 and the interference portion S25, and the fixed-side flange S26 moves vertically (vertically in the ferrule end surface). The interference portion S25 is provided with grooves on the left and right, and the outer frame portion S27 is provided with protrusions so as to engage with the grooves provided on the left and right of the interference portion S25. A gap is provided between the left and right portions of the interference portion S25 and the outer frame portion S27, and the interference portion S25 moves left and right (horizontally on the ferrule end surface).

In FIG. 12, each of the fixed-side flange S26 and the interference portion S25 is provided with one set of groove and protrusion in the vertical direction. However, the number of grooves and protrusions is not limited to this as long as the grooves and protrusions can be moved in the vertical direction. The interference portion S25 and the outer frame portion S27 are provided with a pair of grooves and protrusions on the left and right sides, respectively. However, the number of grooves and protrusions is not limited to this as long as the grooves and protrusions are movable to the left and right.

The movement of the fixed-side flange S26 is vertical, and the movement of the interference portion S25 is horizontal. However, it is sufficient that the end surface of the fixed-side ferrule S13 can move to up and down and left and right (horizontally and vertically), and the present invention is not limited thereto. For example, a shape may be employed in which grooves are provided on the left and right of the fixed-side flange S26 and the fixed-side flange S26 moves left and right, and grooves are provided on the upper and lower sides of the interference portion S25 and the interference portion S25 moves up and down, so that the end surface of the fixed-side ferrule S13 moves up and down and left and right (horizontally and vertically).

Although the fixed-side flange S26 is provided with a groove in a circular shape, the fixed-side flange S26 may have a shape other than a circular shape as long as the fixed-side flange S26 can move up and down. As described above, by limiting the movable range of the fixed-side flange S26, the interference portion S25, and the outer frame portion S27 by the upper, lower, left, and right grooves and the protrusion, the end surface of the fixed-side ferrule S13 can be held so as to be movable in the horizontal and vertical directions and not to rotate about the ferrule shaft.

In the present disclosure,
end surfaces of two ferrules in which single-core fibers are arranged parallel to the central axis Ac and at the same distance from the central axis Ac are abutted on each other such that the central axes Ac match each other;
the flange attached to any one of the ferrules is held by using a holder so as to be movable in the horizontal and vertical directions with respect to the ferrule end surfaces and not to rotate about the central axis Ac; and
while the two ferrule end surfaces are abutted on each other by the spring, the other ferrule is rotated about the central axis Ac.

Accordingly, in the present disclosure, it is possible to switch opposing optical fibers while maintaining good optical characteristics. By forming the end portions of the two ferrules into a convex shape, abutting the distal end portions S19 of the end portions of the two ferrules so that the central axes thereof match each other, and rotating either one of the ferrules, it is possible to prevent deterioration of optical characteristics such as a connection loss due to scratches on the end surfaces of the optical fibers caused by contact without contact between the end surfaces of the optical fibers facing each other. Since the amount of light reflection can be reduced by making the end surfaces of the opposing optical fibers non-parallel to each other, it is possible to provide a more economical optical connection device without requiring reflective coating and an optical switch using the optical connection device.

In the present disclosure, since one of the input side and the output side of the optical connection device that performs optical switching is a mechanism that can axially rotate, energy required by the actuator, that is, torque output can be reduced as much as possible, and power consumption can be reduced. Since the optical axial deviation amount in the direction other than the axial rotation of the rotating-side ferrule S14 is guaranteed by the cylindrical sleeve S15, the loss can be reduced. In addition, the present disclosure does not include collimation or a special vibration damping mechanism, and is made of a generally widely used optical connection component such as a ferrule or a sleeve, and thus is small and economical.

Therefore, according to the present disclosure, it is possible to provide an optical connection device capable of achieving stable optical characteristics with respect to external factors such as temperature and vibration with low power consumption and more economically, and an optical switch using the optical connection device. As a result, in an optical fiber line using single-mode optical fibers in an optical fiber network, the optical switch according to the present disclosure can be used as an optical switch that switches paths in any facility regardless of places.

### Second Embodiment

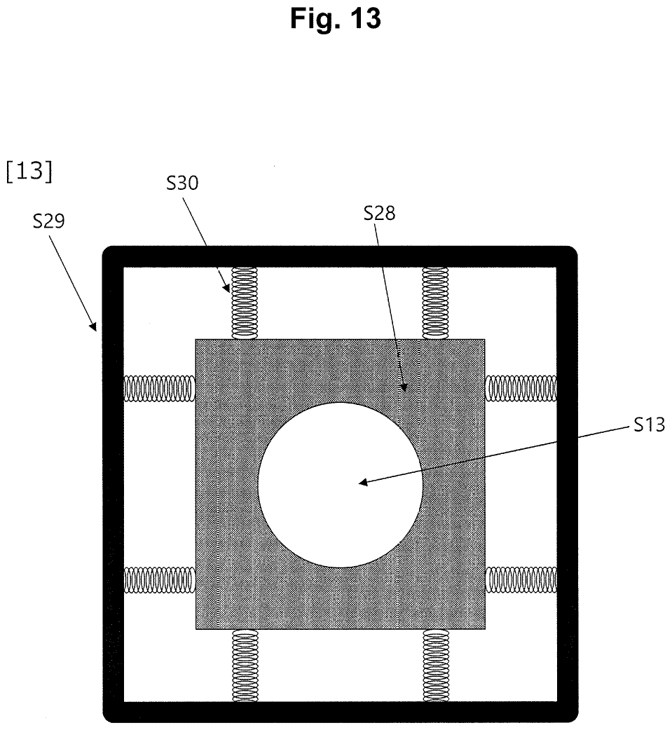

FIG. 13 is a schematic diagram illustrating a cross section of the inside of the fixed-side flange holding unit S16 according to an embodiment of the present disclosure. The springs S30 are provided on the upper, lower, left, and right sides of the fixed-side flange S28, respectively, and are fixed to the inner side of the outer frame portion S29, so that, for example, the fixed-side ferrule can also move horizontally and vertically on the ferrule end surface following the rotating-side ferrule that similarly moves horizontally and vertically by the horizontal and vertical movement of the shaft of the motor. By providing a plurality of springs S30 having the same spring constant on the upper, lower, left, and right sides of the fixed-side flange S28, the fixed-side flange S28 can be stopped with respect to the rotational angle direction.

In FIG. 13, two springs S30 are provided on each of the upper, lower, left, and right sides of the fixed-side flange S28. However, the fixed-side ferrule may move horizontally and vertically on the ferrule end surface following the rotating-side ferrule, and may be stationary in the rotational angle direction, and the number of springs is not limited thereto. The members attached to the upper, lower, left, and right sides of the fixed-side flange S28 may be an elastic body, and for example, rubber or the like can be used instead of the spring.

### INDUSTRIAL APPLICABILITY

An optical connection device and an optical switch using the same according to the present disclosure can be applied to the optical communication industry.

### REFERENCE SIGNS LIST

S1 Input-side optical fiber
S2 Inter-optical-switch optical fiber
S3 Latter-stage optical switch constituent unit
S4 Output-side optical fiber
S5 Former-stage optical switch constituent unit
S6 Rotating-side flange
S7 Holder
S8 Fixed-side optical fiber
S9 Rotating-side optical fiber
S10 Rotation mechanism
S11 Actuator
S12 Control circuit
S13 Fixed-side ferrule
S14 Rotating-side ferrule
S15 Cylindrical sleeve
S16 Fixed-side flange holding unit
S17 Spring
S18 Flange holding unit fixing protrusion portion
S19 Distal end portion
S20 Annular portion
S21, S23 Ferrule outer diameter
S22, S26, S28 Fixed-side flange
S23 Ferrule outer diameter
S24 Sleeve inner diameter
S25 Interference portion
S27, S29 Outer frame portion
S30 Spring

1. An optical connection device comprising:
a first ferrule in which core centers of one or a plurality of single-core fibers are arranged on an identical circumference from a center in a ferrule cross section;
a second ferrule in which core centers of a plurality of single-core fibers are arranged on a circumference having the same diameter as a diameter of the circumference on which the core centers of the single-core fibers in the first ferrule are arranged, from a center in a ferrule cross section;
a cylindrical sleeve having a hollow portion into which the first ferrule and the second ferrule are inserted so that a central axis of the first ferrule and a central axis of the second ferrule match each other, and having a predetermined gap between outer diameters of the first ferrule and the second ferrule and an inner diameter of the hollow portion so that the first ferrule or the second ferrule is rotatable;
a spring that applies pressure to a first flange of the first ferrule or a second flange of the second ferrule so that a distal end portion of the first ferrule and a distal end portion of the second ferrule abut on each other; and
a holder that holds the first ferrule, the second ferrule, the cylindrical sleeve, the first flange, the second flange, and the spring such that the central axis of the first ferrule and the central axis of the second ferrule match each other,
wherein the first ferrule or the second ferrule is movable in any direction perpendicular to the central axis in the holder, and is held by the holder so as not to rotate about the central axis.

2. The optical connection device according to claim 1,
wherein the first ferrule and the second ferrule each have a distal end portion having a convex shape protruding toward the central axis,
an end portion of the first ferrule includes
the distal end portion having the convex shape, and
an annular portion that is arranged on an outer periphery of the distal end portion and from which end surfaces of the single-core fibers arranged in the first ferrule are exposed,
an end portion of the second ferrule includes
the distal end portion having the convex shape, and
an annular portion that is arranged on an outer periphery of the distal end portion and from which end surfaces of the single-core fibers arranged in the second ferrule are exposed, and
the distal end portion of the first ferrule and the distal end portion of the second ferrule are abutted on each other.

3. The optical connection device according to claim 2,
wherein the distal end portion of the first ferrule and the distal end portion of the second ferrule have flat surfaces perpendicular to the central axis.

4. The optical connection device according to claim 3,
wherein an angle formed by the flat surfaces of the distal end portions and the annular portions in the first ferrule and the second ferrule is 5 degrees or more.

5. The optical connection device according to claim 1,
wherein a gap between end surfaces of the single-core fibers exposed to the annular portion of the first ferrule and end surfaces of the single-core fibers exposed to the annular portion of the second ferrule whose optical axis match an optical axis of the single-core fibers of the first ferrule is 20 μm or less.

6. The optical connection device according to claim 1,
wherein, in the holder, the first ferrule or the second ferrule is movable in a direction parallel to the central axis.

7. An optical switch comprising:
the optical connection device according to claim 1; and
a rotation mechanism that rotates one of the first ferrule and the second ferrule of the optical connection device about the central axis.
